(19) United States
(12) Patent Application Publication
(10) Pub. No.: US 2005/0155042 A1
(43) Pub. Date: Jul. 14, 2005

(54) Component-based system for distributed applications

(76) Inventors: Michael Kolb, Richmond, CA (US); Mason Jones, San Francisco, CA (US); Steven Hunter, Oakland, CA (US)

Correspondence Address: Andre M. Gibbs;BLAKELY, SOKOLOFF, TAYLOR & ZAFMAN LLP, Seventh Floor, 12400 Wilshire Boulevard, Los Angeles, CA, 90025-1026, US

(21) Appl. No.: 10/190,161

(22) Filed: Jul. 2, 2002

Related U.S. Application Data
(60) Provisional application No. 60/302,803, filed on Jul. 2, 2001.

(51) Int. Cl. G06F 9/46

(52) U.S. Cl. 719/318; 719/317

(57) ABSTRACT

A framework that allows a transition from a conventional object method invocation model to a services model, where services are explicitly represented and managed before actually being invoked is described. According to one aspect of the invention, a runtime configurable component-based system is described having a plurality of services. Each service includes a set of properties describing the service. The properties include at least, a set of configuration properties to describe functionalities of the service, a lifecycle property to describe a state transition flow of the service for a specific runtime instance, a state property to describe each state in the lifecycle, and a set of dependency properties to describe inter-dependencies of the service with other services of the plurality of services while within a specific state in the lifecycle.

### CROSS-REFERENCE TO RELATED APPLICATIONS

This application claims the benefit of U.S. Provisional Application No. 60/302,803, filed Jul. 2, 2001.

### FIELD OF INVENTION

The present invention relates to software engineering design, and more particularly, to a component-based system for distributed applications.

### BACKGROUND OF THE INVENTION

A component provides an extension to object-oriented software engineering design, in that components allow the grouping of objects together and the ability to use them in a reusable fashion. A typical component-based architecture is COM (Component Object Model), available from Microsoft Corporation, and enables programmers to develop objects that can be accessed by any COM-compliant application. The component architecture has also been extended and used in distributed settings. Typical examples include CORBA (Common Object Request Broker Architecture, an architecture that enables objects to communicate with one another regardless of what programming language they are written in or what operating system they run on) and DCOM (Distributed Component Object Model, an extension of COM that supports objects distributed across a network). Unfortunately, current component architectures are either tightly or loosely coupled. A tightly coupled architecture, such as CORBA or DCOM, implies that there is a tight coupling between the definition and execution of processes. The interfaces to and dependencies among all the components must be known prior to execution. This is difficult to achieve if new components appear in a system dynamically. There is thus a need for a component-based system for distributed applications. It is to this end that the present invention is directed.

### SUMMARY OF THE INVENTION

The invention provides a framework that allows a transition from a conventional object method invocation model to a services model, where services are explicitly represented and managed before actually being invoked. According to one aspect of the invention, a runtime configurable component-based system is described having a plurality of services. Each service includes a set of properties describing the service. The properties include at least, a set of configuration properties to describe functionalities of the service, a lifecycle property to describe a state transition flow of the service for a specific runtime instance, a state property to describe each state in the lifecycle, and a set of dependency properties to describe inter-dependencies of the service with other services of the plurality of services while within a specific state in the lifecycle.

### BRIEF DESCRIPTION OF THE DRAWINGS

FIG. 1 is a diagram illustrating an exemplary peer-to-peer architecture;

FIG. 2 is a representative diagram illustrating a typical agent lifecycle;

FIG. 3 is a representative diagram illustrating possible states for agent services during the lifecycle of the agent;

FIG. 4 is a diagram illustrating a class diagram which shows exemplary agent services that may comprise an agent and the communication/dependency amongst such services and interfaces;

FIG. 5 illustrates an overview of the PeerBeans Application Programming Interface including such interfaces and classes and their respective methods; and

FIG. 6 illustrate pseudo code for an agent startup and halting process according to another embodiment of the invention.

### DETAILED DESCRIPTION OF THE PREFERRED EMBODIMENT

The invention provides a software engineering solution that preferably utilizes a Java framework referred to herein as PeerBeans™ (although the invention may be implemented using other architectures as well, and the present disclosure is not intended to be limiting). Such a framework allows a transition from a conventional object/method invocation model to a services model, where services are explicitly represented and managed before actually being invoked.

Advantageously, the PeerBeans™ framework extends the well-known JavaBeansN reusable component model to that of offering the functionality of a process to other processes. The framework allows for decoupling the definition and representation of a process from the process itself and its use, which enables independent development of the individual components of a distributed system with their actual integration (i.e., an establishment of an interoperation framework, occurring late in the overall software development lifecycle. Advantageously, the individual components need not even have been originally designed with integration in mind. As such, the PeerBeans™ framework provides a loosely coupled component-based middleware framework allowing for software functionality to be automatically accessed and used by other components.

The invention thus provides a system of pre-defined components and interfaces which enables the rapid development of distributed applications. These components and interfaces are described in more detail below. The coupling between the components ranges from tight to loose, as the system designer wishes. In particular, the invention allows for easy description and management of the dependencies among components. Specialized components enable the providing of coordination and communication services among components across the network.

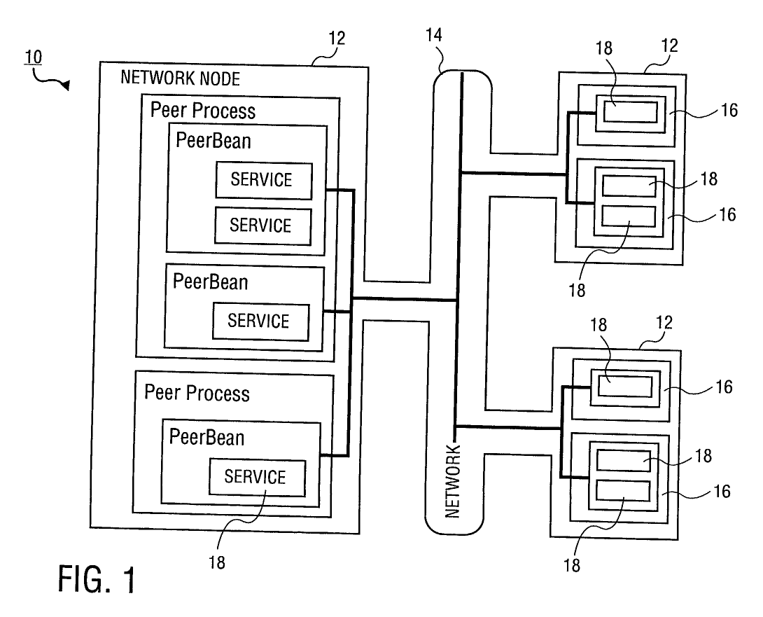

In order to provide the programmatic context for PeerBean™ it is important to introduce several concepts relating to the architecture of a peer-to-peer system. FIG. 1 is a diagram illustrating an exemplary peer-to-peer architecture 10. The architecture 10 may include one or more network nodes 12 connected via a network 14. A network node 12 (i.e., an arbitrary computing device) may include PCs, servers, mainframes, mobile devices, etc. One or more peer processes 16 may run on a node 12. A peer process 16 (or peer, or agent) is a computing process. Several peer processes 16 may run on a single node 12 simultaneously. A node 12 need not be connected to the network 14 at all times (i.e., in the case of a wireless PDA). Peers 16 may maintain one or more logical connections to the network 14. Through their connections, peers 16 are able to either provide services 18 to other peers 16 or request services 18 of other peers 16 (or both). As such, a peer 16 may act as both a client and a server to other peers 16.

In order to handle the requirements of dynamically managing change in a peer-to-peer system, mechanisms must be put into place for being able not only to execute services 18, but also to manage them. This includes discovery, handshaking (i.e., agreeing on and/or handling communication protocols, content representation formats, and business processes), coordination, distribution, authentication and security, etc. Specialized system services, called interoperability services, provide these “meta level” mechanisms. Thus, a collaborative business process (CBP) can be created as a sequence of domain-specific and interoperability services that achieve a particular business goal or objective, as will be described below. In accordance with the invention, the control and execution of such collaborative business processes may be distributed and shared among a number of peers 16.

The portion of the business process related to a specific peer 16 may be specified upon configuration of the peer 16 or may be dynamically loaded by the peer 16 from an appropriate business process repository service. Each peer 16 is preferably responsible for the execution of its relevant portion of the business process. Coordination of the business process across peers 16 is achieved automatically by sending and receiving messages corresponding to synchronization points in the business process.

For example, consider a scenario where a number of vendors offer Product A at different prices. Each vendor is represented by its own peer process 16, running on a computer 12 at the vendor's site or hosted by an external service provider. Each peer process 16 provides the service of selling Product A at the price specified by its corresponding vendor. The vendors can, at any time, change the prices, and even change their individual pricing mechanisms. The peer processes 16 representing respective vendors are automatically updated with the pricing desires of those vendors. Thus, a customer desiring Product A can choose among several collaborative business processes to select an appropriate vendor. These may include, for example, a direct query process, a sealed-bid contracting process, or a multi-stage open-bid negotiation process. It should be noted that, while aspects of the invention are exemplified using a bidding-type scenario, the invention has a wider applicability and such examples are merely illustrative in nature. The acts of finding appropriate vendors, querying them for prices, negotiating and confirming the order are all domain-independent and are supported by interoperability services. The actual processes of forming price quotes (by the vendors) and evaluating the quotes (by the requester) are domain-dependent and are represented by the domain services.

An agent (or peer process, or peer) 16 may be designed according to a component model. That is, an agent 16 is simply the execution environment (container) for a number of defined components, known as Agent Services and implement an Agent Service interface. Preferably, each of the components of an agent 16 follows a pre-defined and common software lifecycle, which will be described below. Some components may depend on other components.

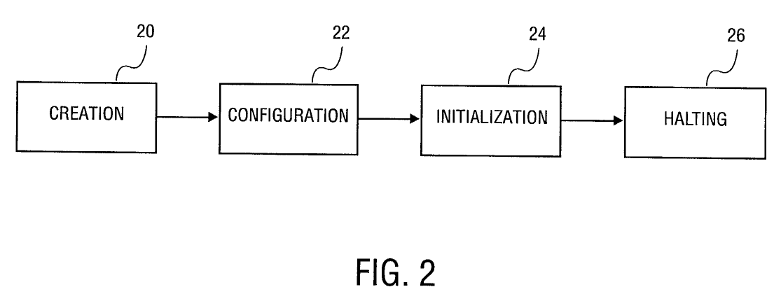

Upon startup, an agent 16 is given a list of all its components, their respective configurations, and inter-dependencies. Preferably, the agent 16 reads this information from a deployment file or from some startup argument. A typical lifecycle of an agent 16, as well as those of its agent services 18 may be represented as follows, and as shown in FIG. 2:
creation→configuration→initialization→halting

During the creation phase 20 of an agent 16, it is preferred that all of its agent services 18 are also created. The agent 16 iterates over the list of all given components and instantiates each component via an empty constructor. After having created actual instances of the components, the agent 16 enters the configuration phase 22. During the configuration phase 22 of an agent 16, preferably all of its agent services 18 are also configured by iterating over the list of all component instances and invoking the configure method on each instance, which is part of the Agent Service interface. The agent 16 configures each agent service instance with its relevant property settings as given by the deployment description. It is assumed that from an agent's perspective all its components are now ready for operation. The agent enters the initialization phase 24. During the initialization phase 24 of an agent 16, all of its agent services 18 are initialized. The agent iterates over the list of now configured agent services and invokes the initialization method on each instance.

After all the services are initialized the agent 16 is considered running. Typically, an agent 16 is halted at a later stage, for example by a user through some form of a user interface, or by a management tool. In response to this, the agent 16 enters the halting phase 26 during which the agent invokes the halt-method on each agent service instance in its list of services to request them to halt, after which the agent 16 halts its own main process.

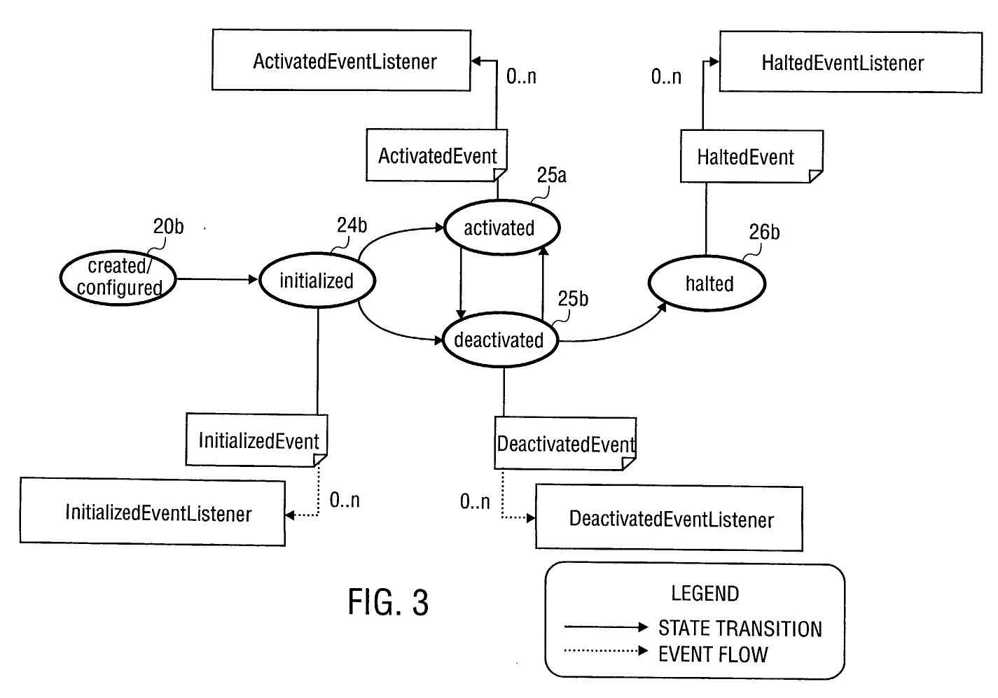

Only the process controlling the agent lifecycle is itself not a component of the agent 16. This process triggers the lifecycle of all the agent's agent services 18. After each phase of the lifecycle, the agent 16 and the agent services 18 can be said to be in any of several states, such as are shown in FIG. 3 and indicated below:
created→configured→initialized→halted

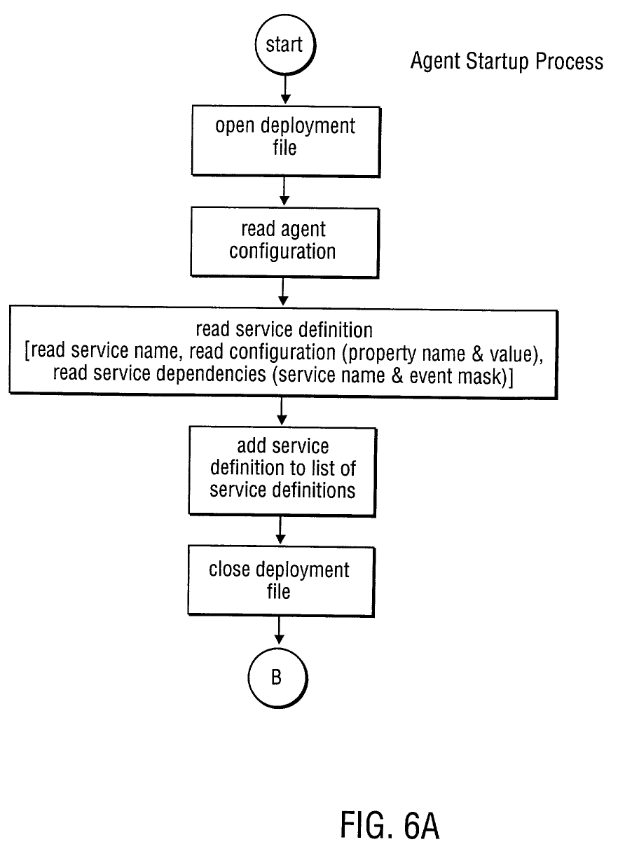

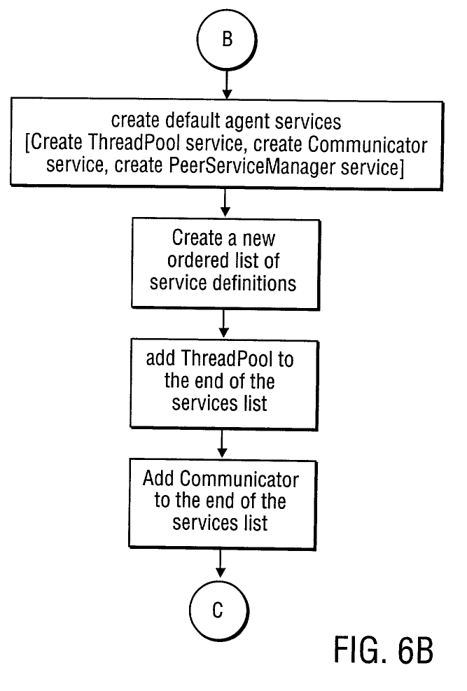

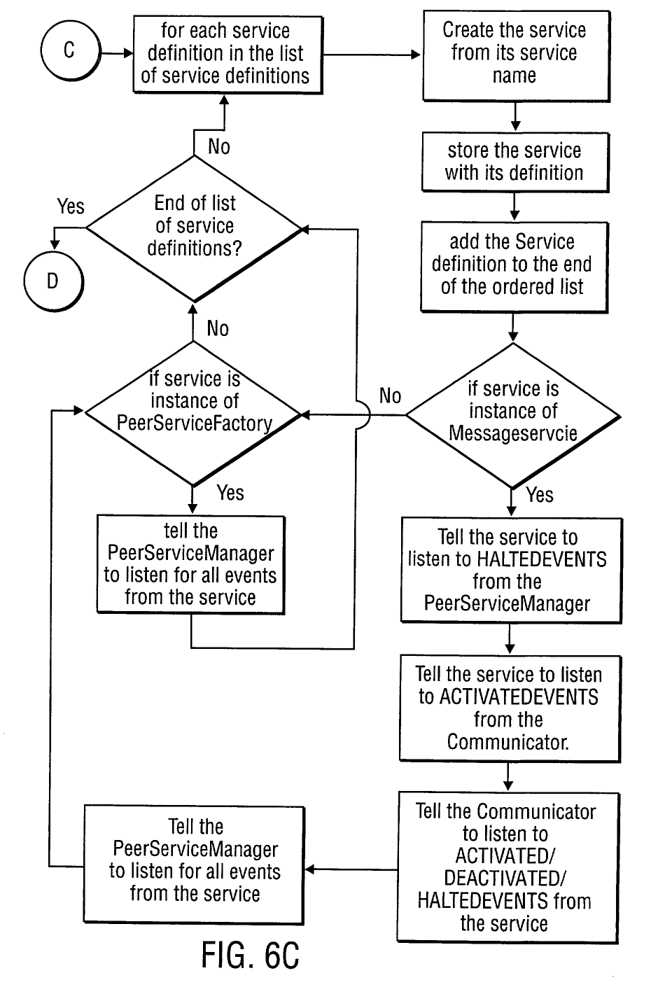

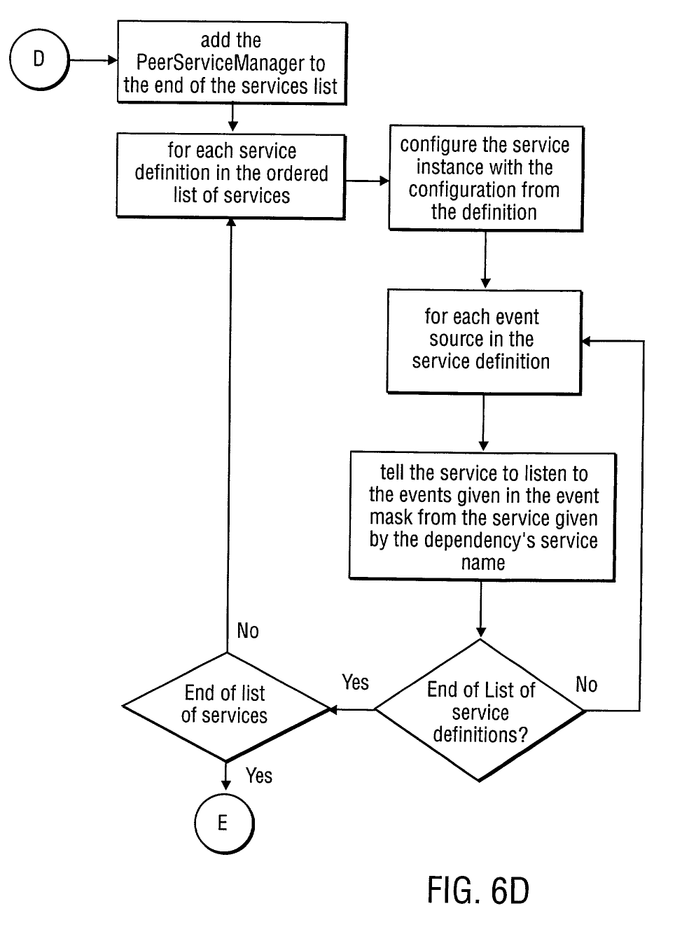

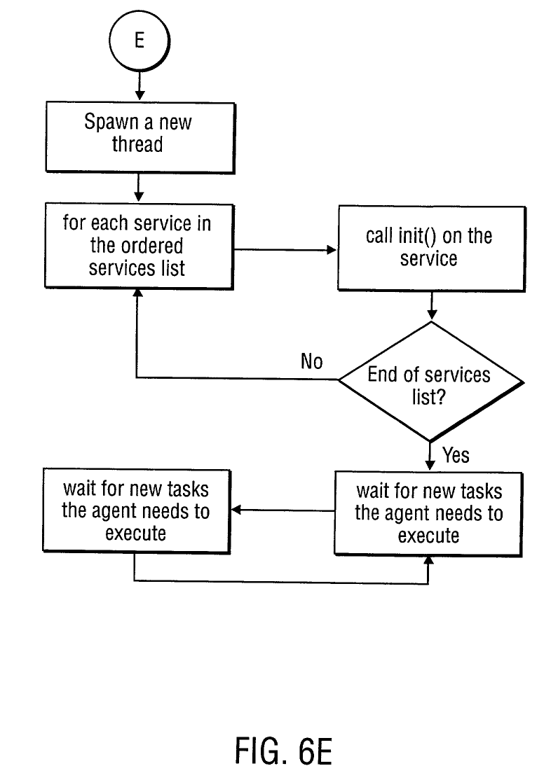

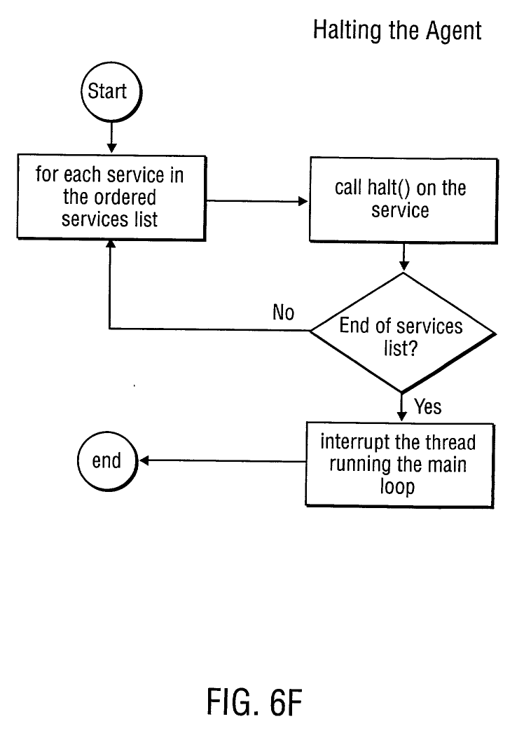

An agent service 18 has two additional states, which occur after it is initialized 24b and before it is halted 26b. These states are active 25a and inactive 25b, and cannot occur simultaneously. The agent services enter these states 25a, 25b independently of the agent. They reflect the internal status of the respective agent service. The transition between these states 25a, 25b is managed by the agent service 18, not by the agent 16. In particular, the agent service 18 may be linked to an external resource 12. After the agent 16 invokes the initialization method on agent service 18, the service establishes a connection to the external resource. Typically, this happens in a different thread of execution, so that the initialization of other agent services does not get delayed. The initialization of the external resource and its availability to the agent service happens asynchronously, i.e., with a time delay that is unknown beforehand. The active 25a or inactive state 25b of agent service 18 is dependent upon the implementation of the external resource. Thus, an agent service 18 may transition from its initialized state 24b to either active 25a or inactive state 25b. From the active state 25a it may transition to the inactive state 25b. In the example of an agent service controlling an external resource, this could be used to reflect a temporary loss of a network connection to the resource. Upon loss of a network connection, the agent service 18 would enter the inactive state 25b. It would remain in the inactive state 25b while it is waiting for re-establishment of the connection. When the resource becomes available, it re-enters the active state 25a. From the inactive state 25b it may transition to active state 25a or to the halted state 26b. The agent service 18 can transition to the halted state 26b only after it is inactive. For example, when halt is invoked on an agent service controlling an external resource, it must first terminate the network connection to the resource, and enter the inactive state 25b, before it halts. FIG. 6 illustrate pseudo code for an agent startup and halting process according to another embodiment of the invention.

Preferably, agent services 18 are aware of their current state, and can communicate which state they are in to other agent services 18. This may be accomplished by passing events to other agent services 18. This is important for managing dependencies among agent services 18 and is described in more detail below.

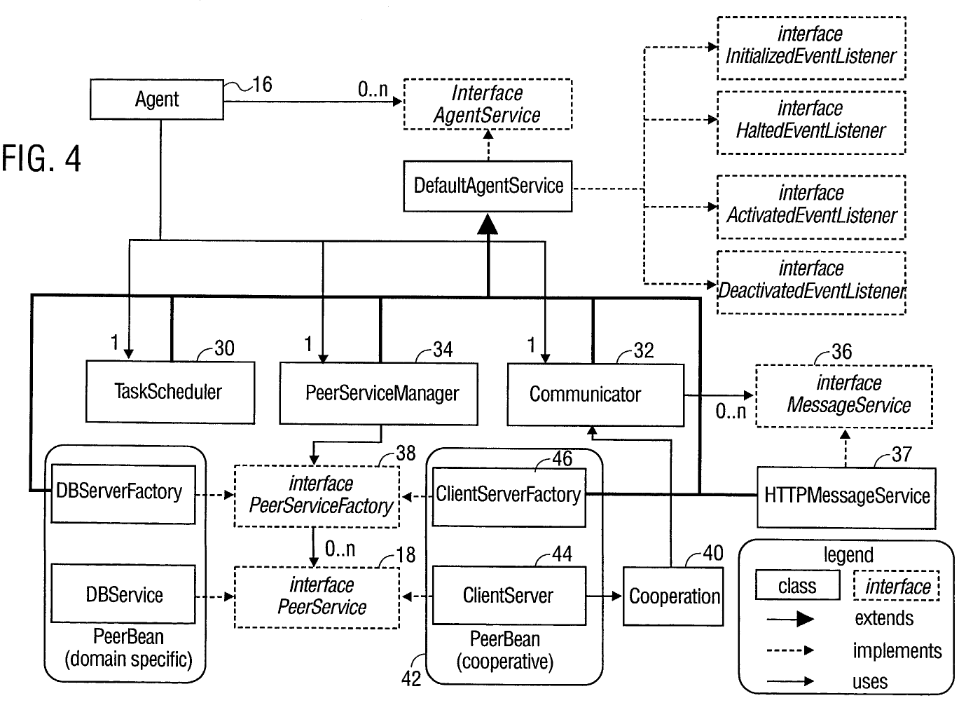

As shown in FIG. 4, an agent 16 may be comprised of certain agent services 18, such as a Task Scheduler 30, a Communicator 32, and a PeerServiceManager (PSM) 34. The Task Scheduler 30 is responsible for handling the processes of an agent 16 on an execution level (tasks). It handles the priorities, synchronization, and scheduling of tasks. For example, in a threading environment, the Task Scheduler 30 runs a main lifecycle thread, and assigns tasks to reusable threads depending on their priorities. The Communicator 32 is responsible for managing the message services provided by an agent 16. The available message services are described by a specialized agent service, known as a Message Service 36. In general, message services allow for communication with other agents 16. One such Message Service 36 may be an HTTPMessageService 37 for implementing HTTP-based messaging. When another agent service 18 (in particular, a cooperation, which will be described below) requests a message service, the Communicator 32 preferably receives this request, looks up the required message service, and forwards the request to the message service. This way, the implementation of messaging is held completely independent from the implementation of those agent services that require messaging. The PeerServiceManager (PSM) 34 is responsible for managing peer services 18 provided by an agent 16. The available peer services 18 are described by a specialized agent service, known as a PeerServiceFactory (PSF) 38. When the agent 16 receives a request for a specific peer service 18, the PSM 34 calls on the corresponding PSF 38 and forwards the request to the resulting peer service 18. The PSF 38 is initialized with a number of PSFs, indicating which peer services 18 the agent 16 provides. For each of the PSFs 38 that are to be made publicly available, the PSM 34 registers service descriptors with an appropriate network registry (e.g., UDDI), so that the peer service 18 can be located by other agents 16.

In one embodiment, a plurality of directory services might be selectively configured for use at run time. The individual directory services can be conventional services such as a UDDI (Universal Description, Discovery, and Integration) service, a DNS service (Domain Name Service), a LDAP service (Lightweight Directory Access Protocol), or others. However, it should be understood that the various embodiments of the invention allow an agent to select directory services at runtime according to the needs of the business process being supported.

An agent 16 may be specified by an Agent Descriptor File (ADF). The ADF preferably contains the agent name, agent-specific configuration parameters, and descriptors of the name of the service, service-specific configuration parameters, and optional service-specific dependencies on other services. Additional application-specific configuration parameters are defined as required in separate files, as specified in the application-specific implementation of the class identified by the service name.

Dependencies among agent services are specified by the Agent Descriptor File, and are handled automatically among the agent services 18. The dependencies may exist in the initialized 24b, active 25a, inactive 25b, and halted states 26b of the agent services 18. When an agent service 18 is created, preferably any dependencies upon other agent services 18 are retrieved from the ADF. If there is a dependency, the other agent service 18 is notified that upon transition to the specified state, it needs to send a corresponding event to the dependent agent service 18. The dependent agent service 18 thus waits on this event before proceeding at the appropriate point. Cyclic dependencies among services are automatically detected by a cyclic link analysis and return an exception.

It should be appreciated that in this way embodiments of the invention allow for a node or agent through a selectable messaging protocol to associate various alternative directory services and various alternative messaging protocols with specific peer services using the PeerServiceManager 34. In this manner, dependencies between peer services can be dynamically created and configured at run-time to support a particular business process.

In accordance with the invention, a PeerBean is represented by a PeerServiceFactory (PSF) 38. There are generally different ways to create PeerBeans. In a domain-specific context, a PSF 38 may be created that corresponds to the domain-specific service that the agent offers. This takes an empty constructor, and is managed by the PeerServiceManager (PSM) 34. In particular, the PSM 34 determines what information to register on the agent network. In an application-independent cooperation context, a PSF 38 may be created which extends the class Cooperation 40 which implements messaging between agents. This gives the programmer access to a standardized set of cooperation primitives, which are essentially mechanisms for handling the cooperation object and mechanisms for synchronizing the flow of cooperation amongst objects. This kind of PSF 38 can operate on data embedded in a problem-solving domain, such as plans, tasks, goals, schedules, and service descriptions. For example, plans are composed of actions. Actions are translated into service requests, including, for example, which agent(s) carry out the service. If the agents are known, in the exemplary embodiment shown in FIG. 4, the service request gets sent to the executing agent via a client/server cooperation 42 (which may comprise a Clientserver service 44 and an associated ClientServerFactory 46). If the agents are not known, and need to be determined, a contracting or auctioning cooperation may first be used to determine the agent.

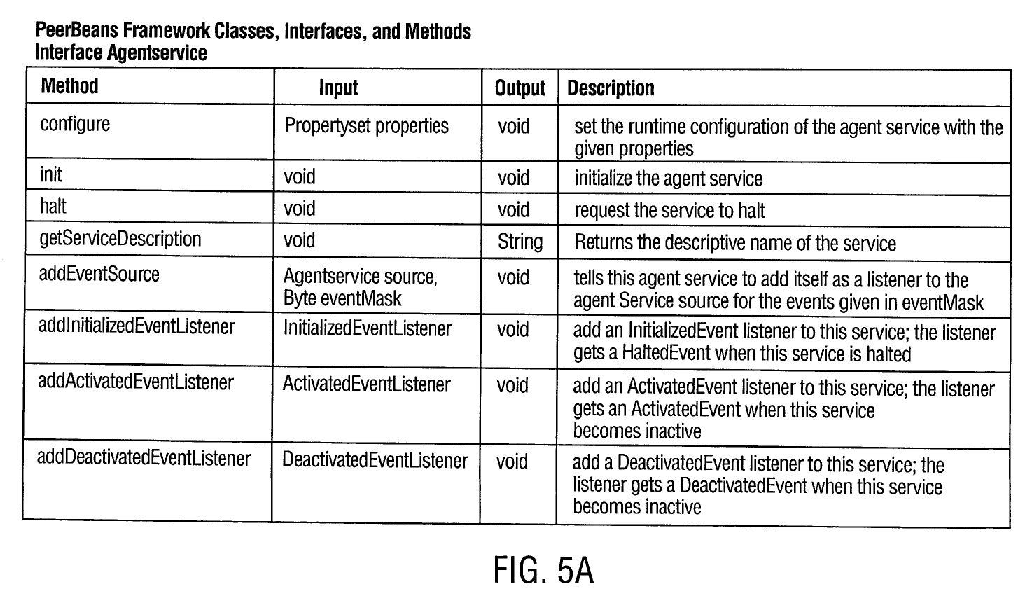

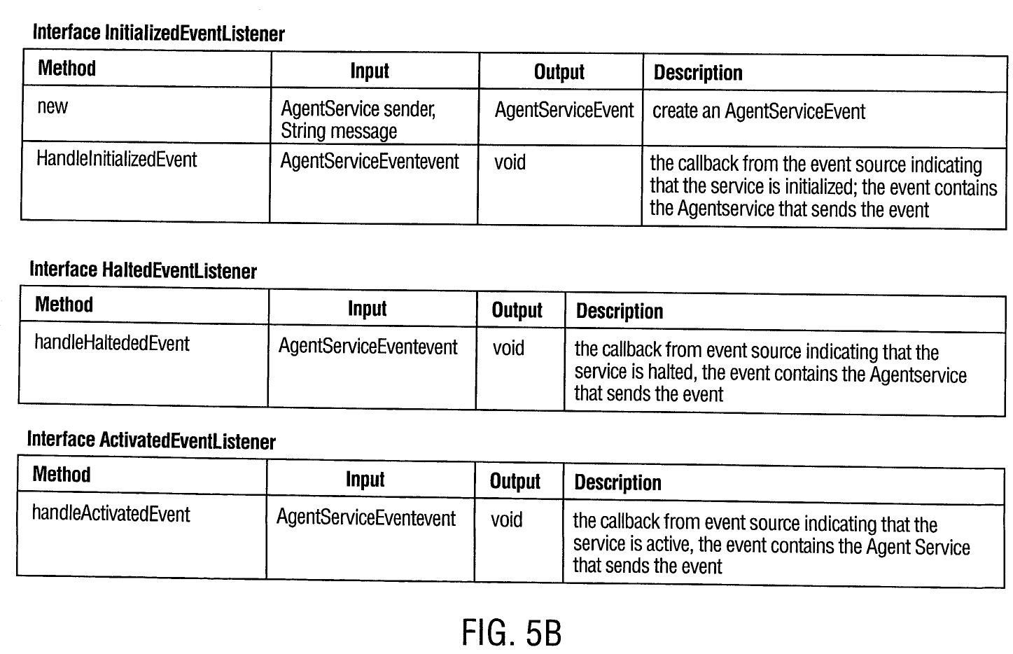

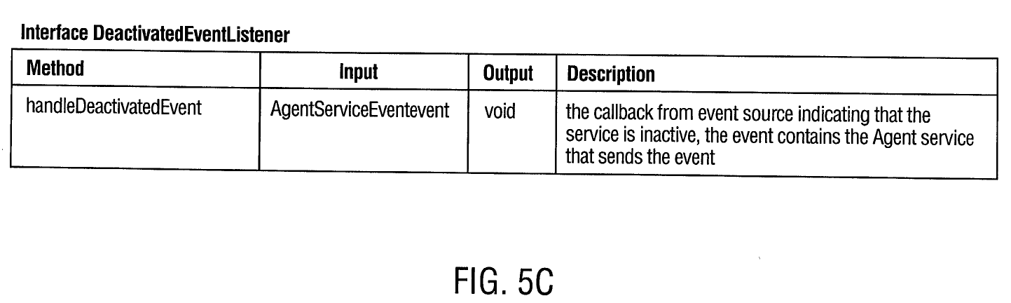

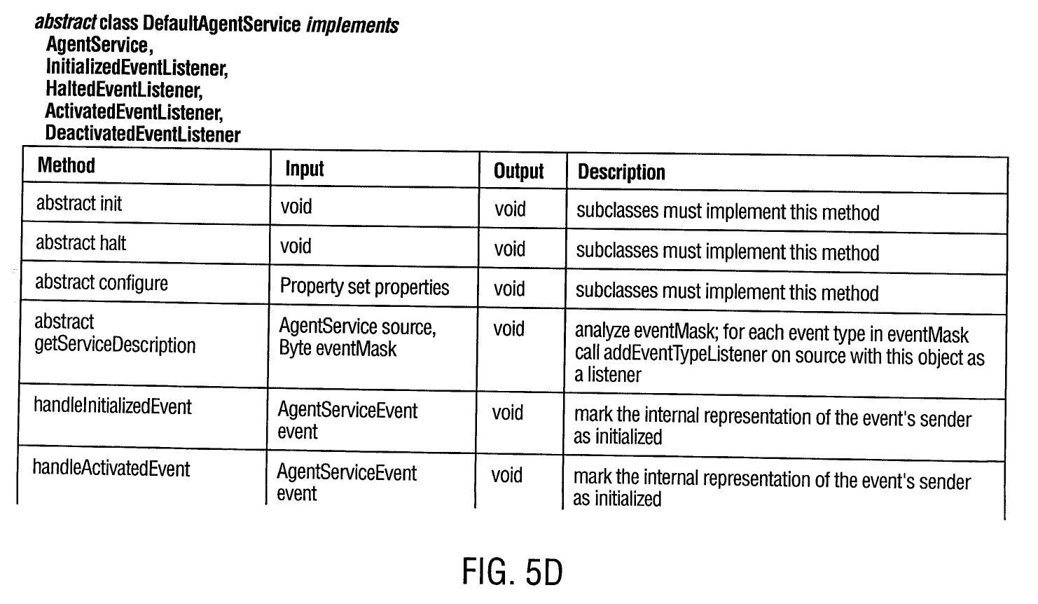

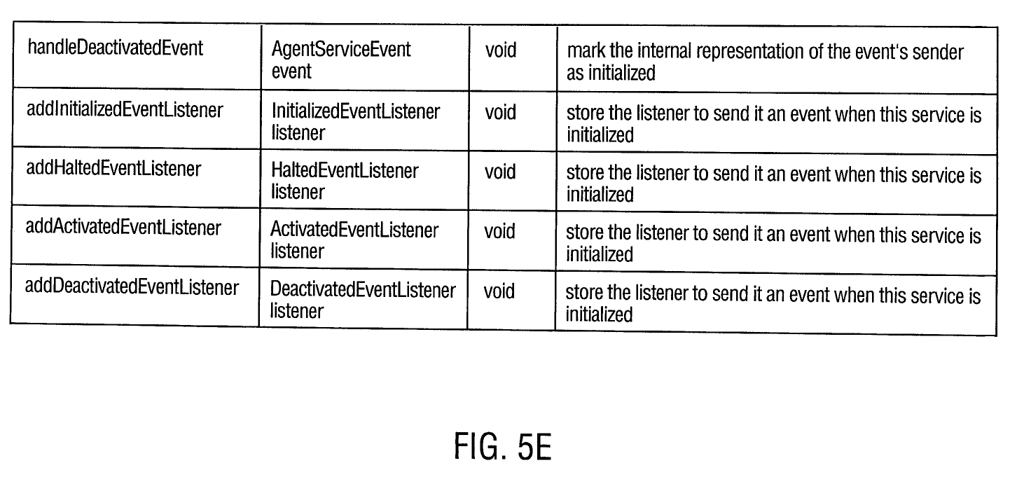

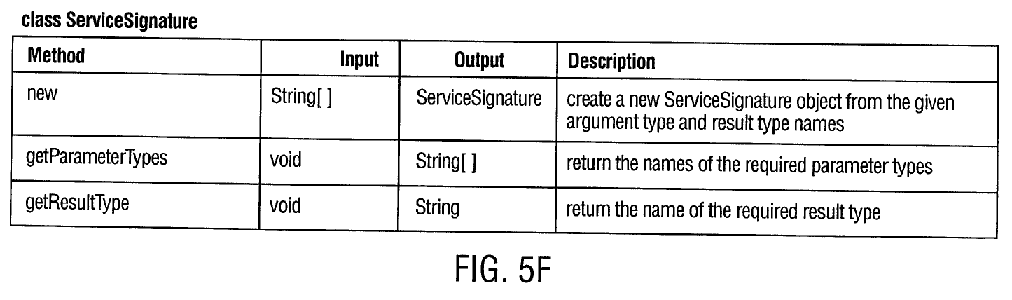

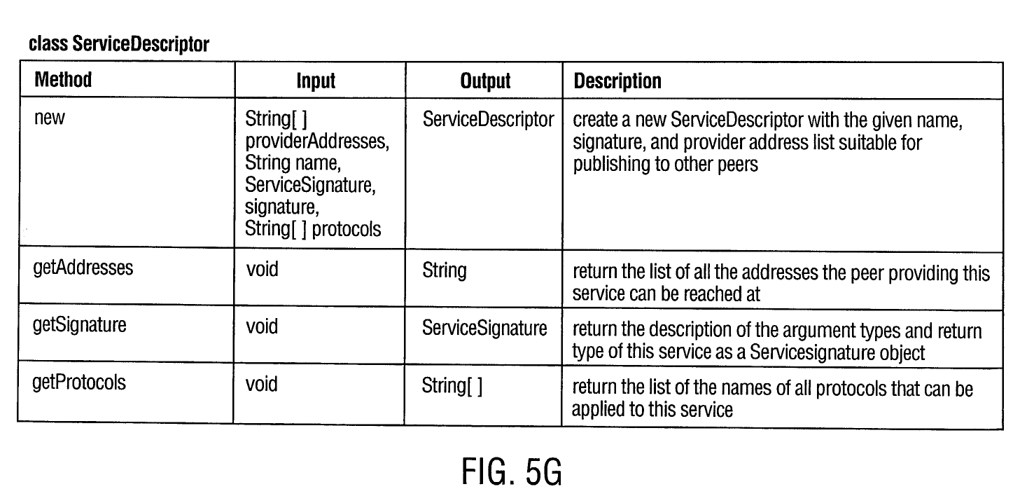

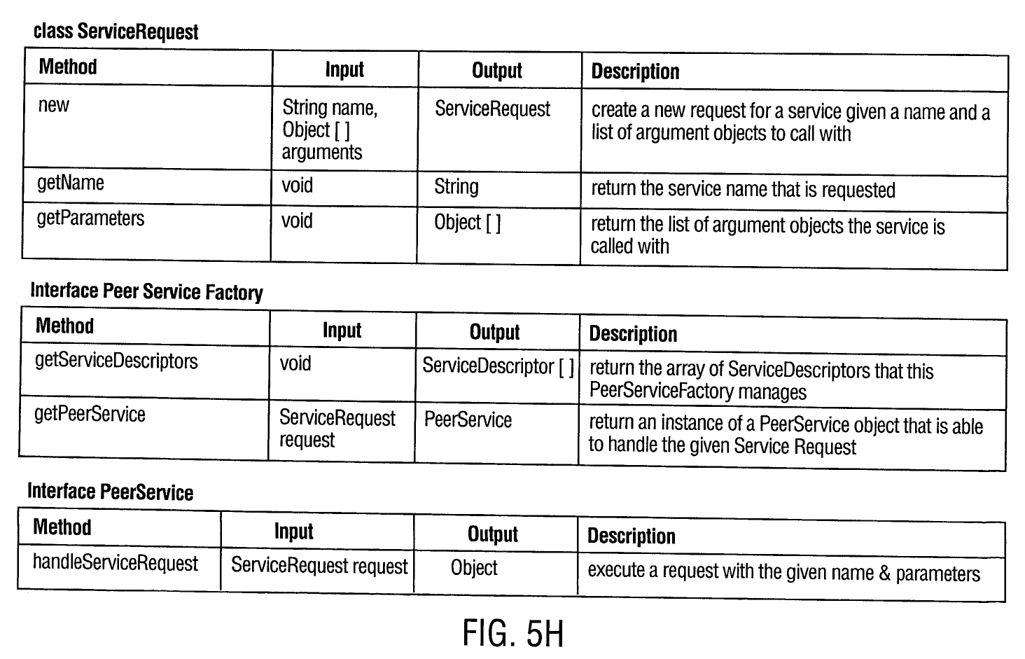

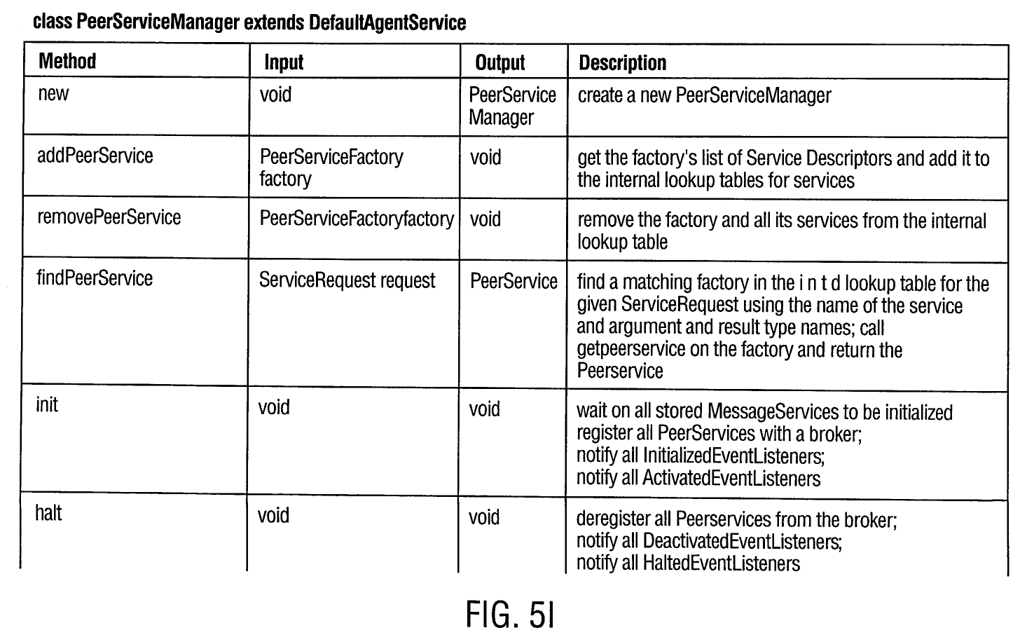

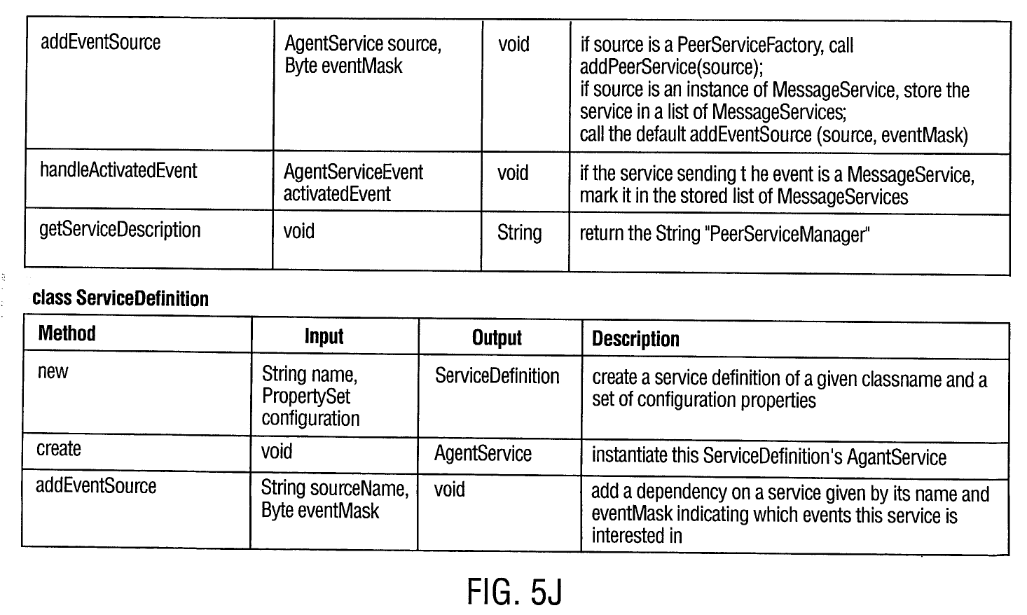

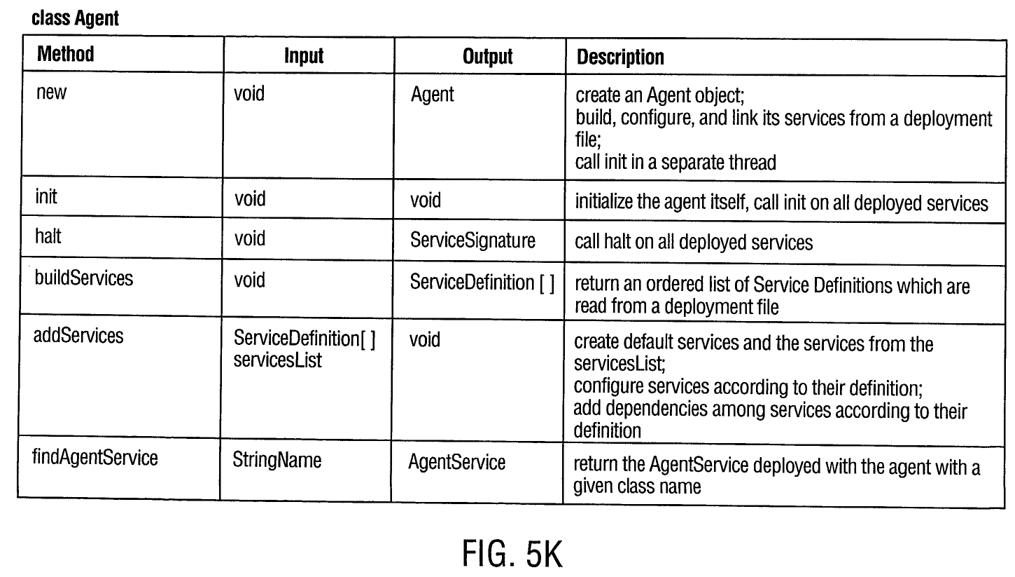

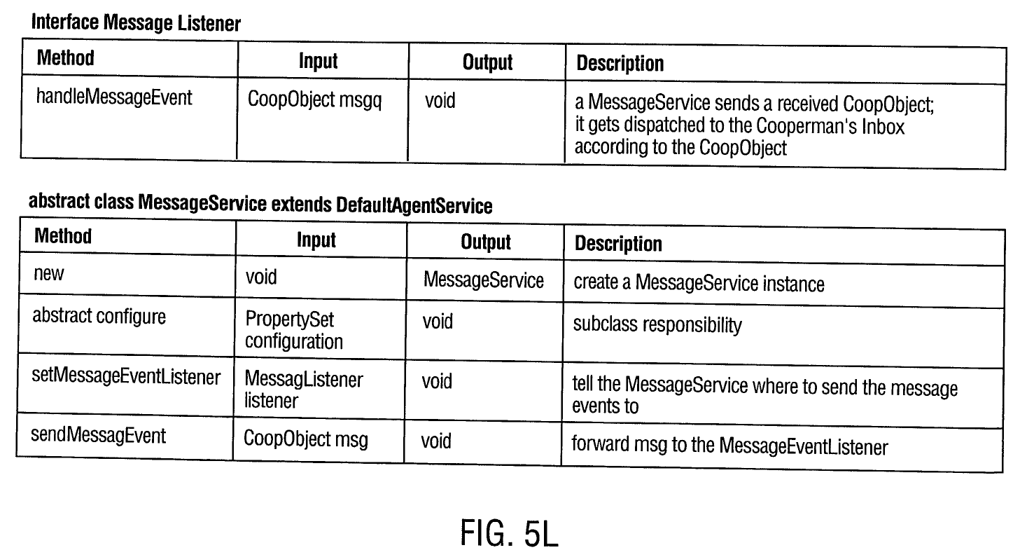

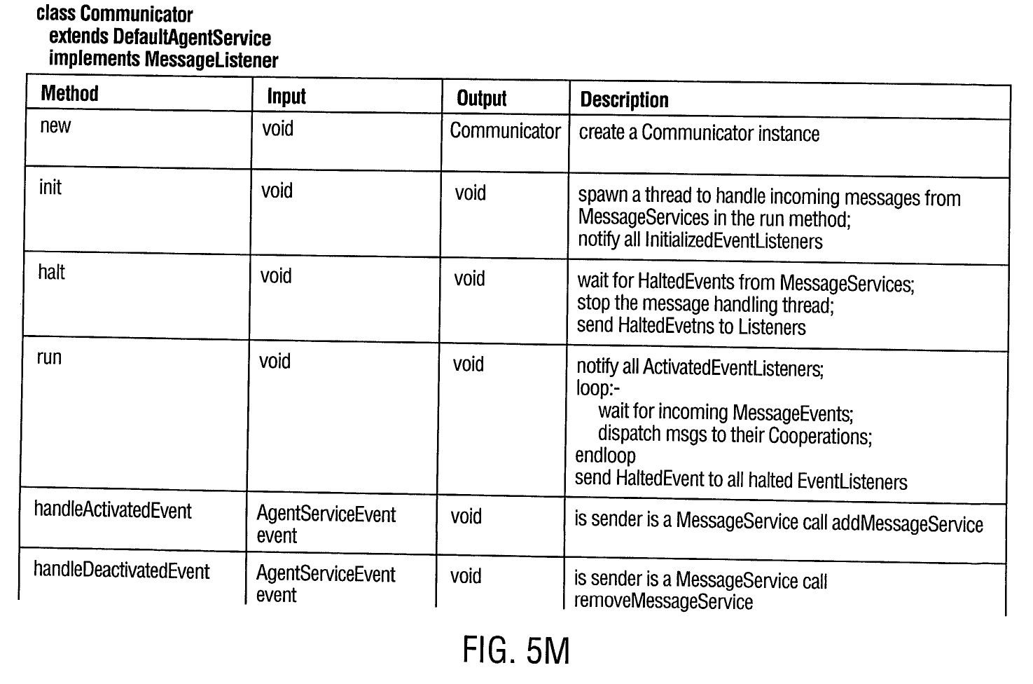

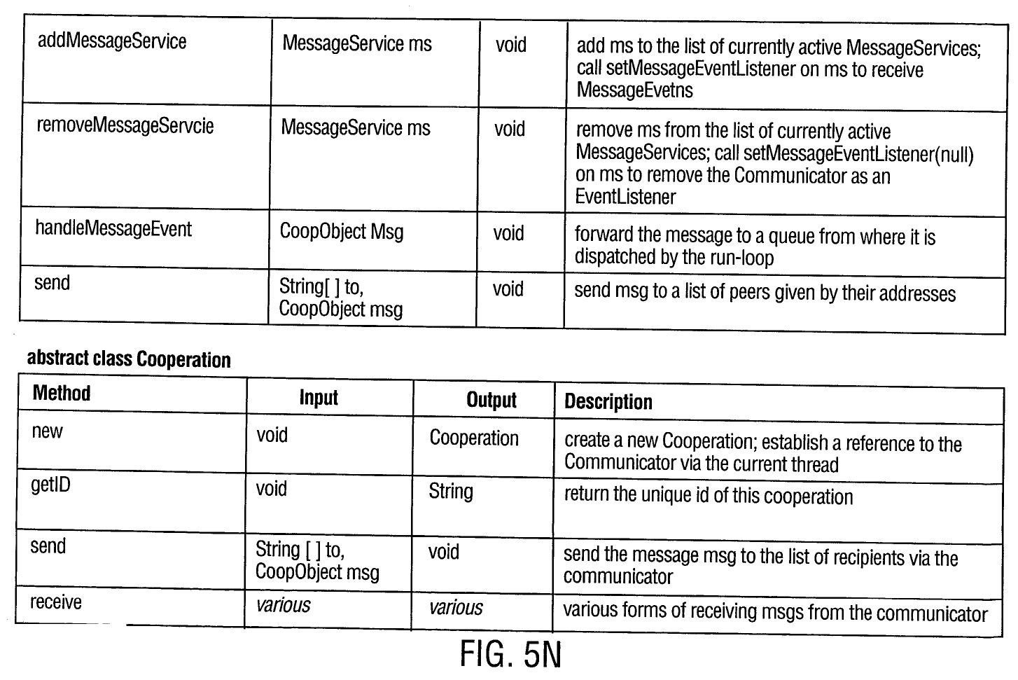

FIG. 5 illustrates an overview of the PeerBeans Application Programming Interface including such interfaces and classes and their respective methods.

The following examples demonstrate the building of a distributed application using the invention. The examples describe two different purchasing scenarios, in which a number of suppliers offer items for sale and a buyer wishes to buy items. The actual products of the suppliers may be fixed (as in a catalogue), but their prices may vary. In these scenarios, the buyer agent offers no services to other agents. The supplier agents offer a PurchaseProduct service. Again, while these examples illustrate the invention's applicability to a purchasing context, the invention is not so limited and has a wider utility. These examples are merely for illustrative purposes.

### EXAMPLE 1

### Simple Client/Server Interaction Between a Buyer and a Supplier

In the first scenario, a buyer may already know the desired supplier for a given product. In this case, the buyer agent may call a Clientserver cooperation for a PurchaseProduct service on that supplier agent. It is important to note that suppliers are automatically included in the system as soon as they specify a service. The agent automatically registers this service with the peer network and, as such, the supplier agents can be found. No additional overhead is required. Using the invention, a supplier agent need only implement the PurchaseProduct service, and the buyer agent need only implement the initiation of the process, and possibly a web-based interface for invocation of the process (perhaps one supporting deciding on the bids of the suppliers). The following pseudo-code represents an implementation of this example.

The class Product represents a shared definition of a product between buyers and suppliers:

```
public class Product {
      String itemname;
      int quantity;
      int price ;
} // end Product
```

In this example, the supplier maintains its product offerings in a catalog. To implement this, a catalog is represented as a simple interface, and a simple datafile catalog implementation is given.

```
public interface Catalog {
  / * *
  * return a list of all available products
  */
  public Product [ ] listproducts ( ) ;
  /**
  * find a product by name
  */
public Product findProduct(String name);
  /**
  */
  * buy a product; adjust stock level in the catalog
  */
  public void buy(Product p ) ;
} / / end Catalog
```

A simple implementation of this catalog interface as a deployable Agentservice is given by:

```
public class DatafileCatalog
  extends DefaultAgentService implements Catalog {
  String datafileName;
  /** empty constructor */
  public DatafileCatalog 0 { }
  /**
  * configure the catalog to use a particular file
  */
  public configure(Pr0perties config) {
  datafileName = config.getProperty(“catalogFile”);
}
/********** the catalog interface implementation*************/
public Product[ ] listProducts( ) {
  // open the datafile,
  // products = read all product records
  // close datafile
  return products;
}
  public Product findProduct(String name) {
  // open the datafile
  // product = find matching record
  // close datafile
  return product;
}
public void buy(Product product) {
  // find the product record in the datafile
  // update the record's quantity
}
}// end Datafilecatalog
```

In this example, the supplier agent offers a PurchaseProduct service. In order to do so, it provides a PurchaseProductFactory, which describes the service and also creates instances of the actual PurchaseProduct implementation. The PurchaseProduct service relies on a catalog service. However, it is independent of: the actual catalog used by the agent. The deployment description of the agent will specify the actual implementation used.

```
public class PurchaseProductFactory
  extends DefaultAgentService implements PeerServiceFactory
{
  /**
  */
  * the catalog to use for this service
  private Catalog catalog;
  /**
  */
  * describe the services offered
public ServiceDescriptor[ ] getServiceDescriptors( ){
  ServiceDescriptor[ ] descriptors = {
      new ServiceDescriptor(“PurchaseProduct”,
                new Servicesignature(
                        new String[ ] { “Product },
                        “*Object”) ,
                null) ;
return descriptors;
}
public Peerservice getpeerservice( ServiceRequest sr {
  return new PurchaseProductImpl(cata1og);
}
/ * *
  */
  * check for catalog dependency
public void addEventSource(AgentService service, byte eventMask) {
  if (service instanceof Catalog) {
  }
      catalog = (Catalog) service;
  super.addEventSource(service, eventMask);
}
/**
  * initialize the service
  */
public void init( ) {
  // wait for services we depend on (the catalog) to become
  // active
  waitOnActivatedEvents( );
  // now we can go live
  notifyInitializedListeners( )
  notifyActivatedListeners( );
}
  /**
  * configure the service
  */
public configure(Properties p) {
  // nothing to configure
}
} // end PurchaseProductFactory
```

An exemplary PurchaseProduct implementation may be as follows:

```
public class PurchaseProductImpl
  implements Peerservice
{
  /**
  * the catalog used for product lookup
  */
  private Catalog productCatalog;
  public PurchaseProductImpl(Cata1og catalog) {
      productCatalog = catalog;
}
  /**
  * handle a purchasing request for a product
  */
public Object handleServiceRequest( ServiceRequest request } {
  // extract the product from the parameters list
  Product p = (Product) ( (request.getparameter( ) } [0] ) ;
  // Update the item quantity in the catalog
  productCatalog.buy(p);
  return (p) ;
}
} // end PurchaseProductImpl
```

The class ClientServerFactory describes and creates instances of the simple client/server protocol:

```
public class ClientServerFactory
  extends DefaultAgentService implements PeerServiceFactory
{
  public ServiceDescriptor[ ] getServiceDescriptors( ) {
      ServiceDescriptor[ ] services = new ServiceDescriptor[ ] {
          new ServiceDescriptor(“clientserver/client”, //service name
                    new Servidesignature ( new string [ ] {
                          “java.lang.Stringl’,
                          “ServiceRequestn } ,
                          “java.1ang.Object”
                    ) ,
                    null / / not used, this is a protocol
                    ),
          new ServiceDescriptor(“clientserver/server,
                          new ServiceSignature( ),
                          null
                          }
  };
  return services;
}
public Peerservice getpeerservice( ServiceRequest sr ) {
return new ClientServerImp( );
  }
} / / end ClientServerFactory
The ClientServerImpl class implements the two roles in the clientserver
protocol:
public class ClientServerImpl extends Cooperation implements Peerservice
{
  /**
  * Accept a service request and handle it. If it is a client
  * request
  * (i.e. the name ends with “client”, we're the initiator;
  * otherwise
  * if it ends with “server” we're the recipient of the request.
  */
public Object handleServiceRequest( ServiceRequest sr ) {
  if ( sr.name.endsWith( CLIENT ) ) {
    return
    client ( (String) sr-parameters [0] ,
        (ServiceRequest) sr-parameters [l] ) ;
  }else{ //server
    server ( ) ;
    return null;
  }
} / / end ClientServerImpl
/ *
  * handle the client side of the service.
  * /
private Object client( String serveraddress, ServiceRequest sr {
  CoopObject result = null;
  CoopObject co = new CoopObject( sr );
  co.protocolServiceRequest =
    new ServiceRequest (“clientserver/server”) ;
  send ( CoopObject -REQUEST, serverAddress , co ) ;
  result = receive ( ) ;
  Object resultObject = result.getObject0;
  return (resultObject) ;
}
/ *
  * handle the server side of the service
  */
private void server {
  ServiceRequest sr = null;
  CoopObject co = receive( );
  ServiceRequest sr = (ServiceRequestIco.getObject( );
  Peerservice ps = PeerServiceManager( ).findPeerService( sr );
  Object result = ps. handleServiceRequest ( sr ) ;
  send( CoopObject.INFORM, co.from, new Coopobject( result ));
  return ;
}
} // end ClientServerImpl
```

With all the components described, a supplier agent can be built from a combination of a message service, the ClientServerFactory, the DatafileCatalog and the PurchaseProductFactory. The following XML-based deployment descriptor file shows an exemplary definition of all the services, their configuration, and all dependencies:

```
<?xml version=“1.0” standalone=”yes”?>
< agent name= “Supplier1” >
  <configuration name=“register” value=“true”></configuration>
  <service name= “msgservices.tcp.TCPMessageService”>
  <configuration name=“port” value= “4321”></configuration>
</service>
  <service name=”ClientServerFactory”></service>
  <service name=“Datafi1eCata1og”>
    <configuration name=”catalogFile” value=”/usr/local/
    mycatalog.dat”>
  </service>
  <service name=“PurchaseProductFactory”>
    <addEventSource name=”DatafileCatalog” event= “ACTIVATED”>
  </service>
</agent >
```

Note the activation dependency between the PurchaseProductFactory and the Datafilecatalog. All other services and dependencies are created by default. A buyer agent can be constructed using the following deployment description:

```
< ?xml version = “1.0” standalone= “yes”?>
< agent name = “Buyer”>
  <configuration name=”register” value=“true”></configuration>
  <configuration name=“port value=“4321”></configuration>
  <service name=”msgservices.tcp.TCPMessageService”>
</service>
  <service name=”ClientServerFactory”s</service>
  <service name=”BuyerWebService”></service>
</agent >
```

The buyer agent may use the following code fragment to actually initiate the purchasing process. This could be part of a web service implementation or triggered from a stand-alone graphical user interface.

```
. . .
    Product product;
    String supplierAddress;
    . . // select product to buy and supplierAddress to buy it from
    Object r =
    callpeerservice (“/clientserver/client”,
              supplierAddress,
              new ServiceRequest (“PurchaseProduct”.,
                                new Object [ ] { product } ) ) ;
. . .
```

Accordingly, as shown in the above example, a buyer may already know the desired supplier for a given product. In this case, the buyer agent may call a Clientserver cooperation for a PurchaseProduct service on that supplier agent. Using the invention, a supplier agent need only implement the PurchaseProduct service, and the buyer agent need only implement the initiation of the process, and possibly a web-based interface for invocation of the process (perhaps one supporting deciding on the bids of the suppliers).

### SECOND EXAMPLE

### Buyer Uses Sealed Bid Contracting—to Select from Several Suppliers

In the second scenario, the buyer may not know which supplier to get the product from. In particular, the buyer may want to choose the supplier with the lowest price for the product. In this case, the buyer agent may use a sealed bid contracting cooperation on the PurchaseProduct service. Once the buyer agent has found the prices from the different suppliers, it can choose its preferred supplier. This can happen either automatically by invoking a pre-programmed decision making process, or the buyer agent can graphically present the choices to the human buyer (e.g. via a web-based interface).

It is important to note that the supplier agents generate the offered prices autonomously, independently, and based on whichever means they have at their internal disposal. This allows one supplier agent to get the price from a database, for example, another supplier agent to get its price from a salesperson (e.g. via a web-based interface), and yet another supplier agent to get the price dynamically based on information about its inventory, current sales history, and from an ERP system. Also, the identity of the buyer may be taken into account in determining the price (e.g. a preferred buyer might receive better prices).

The following classes represent the sealed bid contracting interaction protocol. A bid in the sealed bid contracting process is represented by an address of who is bidding and a service request containing the offer.

```
public class ContractNetBid {
  public String from;
  public ServiceRequest serviceRequest;
  public ContractNetBid(String from, ServiceRequest sr) {
      this.from = from;
      this.serviceRequest = sr;
  }
} / / end ContractNetBid
```

The following interface may be implemented by the manager in the actual application domain:

```
public interface ContractNetManager {
  / * *
  * eval the bids and find the winning bidder
  */
  public ContractNetBid evalBids(ContractNetBid[ ] bids);
} // end ContractNetManager
```

The following interface may be implemented by each bidder in the actual application domain:

```
public interface ContractNetBidder {
  / * * make a bid from a call for bids */
  public ServiceRequest makeBidServiceRequest cfb);
} // end ContractNetBidder
```

The following pseudo-code highlights an implementation of the interaction protocol service factory as a deployable Agentservice:

```
public class ContractNetFactory
  extends DefaultAgentService implements PeerServiceFactory {
  public ContractNetFactory( ){
    }
public ServiceDescriptor[ ] getServiceDescriptors( ) {
  ServiceDescriptor[ ] services = new ServiceDescriptor[ ] {
    new ServiceDescriptor(BB/contractnet/managerB1, //service name
        new Servicesignature (new string [ ] {
                            “String” ,
                            “ServiceRequest”,
                            “Integer”
                            }
                            “Object”),
                      null),// this is a protocol
        new ServiceDescriptor(“/contractnet/bidder”,
        new ServiceSignature( ),
        nu11)
  };
return services;
}
public Peerservice getpeerservice( ServiceRequest sr ) {
return new ContractNetImpl( );
}
} // end ContractNetFactory
public class ContractNetImpl
extends Cooperation implements Peerservice {
public Object handleServiceRequest( ServiceRequest sr) {
  if ( sr.name.endsWith(“manager”) ) {
    return manager ((String[ ]) sr.parameters[0] ,
        (ServiceRequest)sr.parameters[l] ,
        (ContractNetManager) (sr.parameters[2]),
        (Integer)(sr.parameters [3]));
    } else { // bidder
        bidder ( ) ;
        return null;
    }
/**
  * the manager role implementation
  * /
private Object manager (String [ ] bidders,
                    ServiceRequest sr ,
                    ContractNetManager cnm,
                    Integer timeout) {
  // send the call for bids
  send ( CoopObject.CFP, bidders,
  // receive all bids within a time period
        new ServiceRequest(“/contractnet/bidder”), sr ));
  Coopobject [ ] replies =
    receiveReply(bidders,co.msgID,timeout);
  // generate agent/request pairs -> bids
  ContractNetBid [ ] bids = generateBids (replies) ;
  ContractNetBid winner = cnm.evalBids(bids);
  // send accept to winning bidder
  send(CoopObject.ACCEPT,winner.from,new Integer(1));
  // send reject to losing bidders
  for (int i = 0; i < bids.length; i++) {
    if (!(bids[i].from.equals(winner.from))) {
    send(CoopObject.REJECT,bids [i].from,new Integer(1));
    }
  }
send(CoopObject.REQUEST,winner.from, winner.ServiceRequest);
CoopObject result = receive( );
return result.getObject( );
}
/**
  * the bidder role implementation
  */
private void bidder( ) {
  CoopObject co = receive( ) ;
  ServiceRequest sr = (ServiceRequest)co.getObject( );
  Peerservice ps = AgentThread.getAgent( ).findPeerService(sr);
  // cast the peer service to bidder
  ContractNetBidder bps = (ContractNetBidder)ps;
  // bidder preparing bid
  ServiceRequest bid = bps.makeBid(sr);
  reply (CoopObject.PROPOSE, co,new Coopobject(bid));
  CoopObject reply = receive ( ) ;
  if (reply.primitive == CoopObject-ACCEPT) {
  // accepted bidder
  CoopObject crq = receive( ) ;
  ServiceRequest req = (ServiceRequest)(crq.getObject( ));
  Object result = ps.handleServiceRequest(req);
  send(CoopObject.INFORM,crq.from,result);
  }
}
/**
  * generate contract net bids for the evaluation,
  * by pairing the service request with the sender of
  * the message
  * /
private ContractNetBid[ ] generateBids(CoopObject[ ] replies {
  ContractNetBid[ ] bids = new ContractNetBid[replies.length];
  for (int i = 0; i < replies.length; i++) {
    bids [i] = new ContractNetBid (replies [i].from,
            (ServiceRequest)(replies[i].getobject( )));
  }
  return bids;
}
} // end ContractNetImpl
```

In order for the suppliers to use the PurchaseProduct service in conjunction with the sealed bid contracting protocol, the PurchaseProduct service can be extended by the ContractNetBidder interface:

```
public class PurchaseProductImpl
  implements Peerservice, ContractNetBidder {
  // same as above plus the following method:
public ServiceRequest makeBid(ServiceRequest cfb) {
  return (SupplierAgent) (getAgent ( )).makeBid(cfb);
}
```

The buyer agent implements the ContractNetManager interface by selecting the cheapest bid:

```
  /**
  */
  * select the cheapest bid
public ContractNetBid evalBids(ContractNetBid[ ] bidlist) {
  int cheapestIndex = −1;
  int cheapestprice = maxInt;
  for (int i = 0 ; i c bidlist-length; i++) {
      Product p = (Product)
      ((bidlist[i].serviceRequest.getparameters( )) [0]) ;
      if (p.price < cheapestprice) {
  cheapestIndex = i;
      }
  }
  return bidlist [cheapestIndex];
}
```

To invoke the contracting for the PurchaseProduct service the following code may be used:

```
  Product product; // the product to buy
  int buyTimeout = 10; // the call for bids waiting period in seconds
  // find all suppliers via the PeerServiceManagCr
  ServiceDescriptor[ ] sds =findServiceProviders (“PurchaseProduct”);
  // extract the suppliers' addresses
  String[ ] suppliers = new String[sds.length ];
  for( int i = 0 ; i < sds.length; i++ ){
    suppliers [i] = sds [i].providerAddresses [0];
}
// use them in the contractnet scenario
ServiceRequest proposal =
  new ServiceRequest (“PurchaseProduct”,
                        new Object [ ] { product } ) ;
result = callPeerService(“/contractnet/manager”, suppliers,
                        proposal, this, buyTimeout);
// the result contains the winning bids
```

The buyer agent may be deployed with the following deployment description:

```
< ?xml version= “1.0” standalone = “yes ?>
< agent name= ”Buyer”>
    <configuration name=”register” value=“true”></configuration>
    <service name=“msgservices.HTTPMessageService”>
        <configuration name=“routerHost” value=“localhost”>
        < /configuration>
    <configuration name=“routerPort” value=“8080”>< /configuration>
  </service>
  <service name=“ClientServerFactory”></service>
  <service narne=“ContractNetFactory”></service>
  <service narne=“BuyerWebService”></service>
< / agent >
```

The supplier agent deployment files may be:

```
<?xml version=“l.0” standalone=“yes”?>
<agent name= “Supplierl”>
  <configuration name=“register” value=“true”></configuration>
  <service name=”msgservices.HTTPMessageService”>
  <configuration name=”routerHost” value= “localhost”></configuration>
  <configuration name=“routerPort” value= “8080”></configuration>
</service>
<service name=“ClientServerFactory”></service>
<service name=”ContractNetFactory”></service>
<service name=”DatafileCatalog”>
  <configuration name=“catalogFile” value= “/usr/local/mycatalog.dat”>
</service>
<service name=“PurchaseProductFactory”>
< addEvent Source name=“Data fileCatalog”event = “ACTIVATED” >
</service>
</agent >
```

The second supplier may use a database catalog:

```
<?xml version=”l.0” standalone=”yes”?>
<agent name = “Supplier2”>
  <configuration name=”register” value=“true”></configuration>
  <service name= “msgservices.HTTPMessageService”>
    <configuration name= “routerHost” value= “localhost”>
    </configuration>
    <configuration name= “routerPort” value= “8080”></configuration>
</service>
<service name= “ClientServerFactory”></service>
<service name= “ContractNetFactory”></service>
<service name= “DatabaseCatalog”>
  <configuration name= “dbHost It value=“ localhost” >
  <configuration name= “dbPort” value=“2134” >
  <configuration name=“dbUser” value=“supplieragent” >
  <configuration name=“dbPassword” value= “password” >
</service>
<service name= “PurchaseProductFactory” >
  < addEvent Source name=“DatabaseCatalog” event =“ACTIVATED”>
  </service>
</agent >
```

Accordingly, the buyer may not know which supplier to get the product from. In particular, the buyer may want to choose the supplier with the lowest price for the product. In this case, the buyer agent may use a sealed bid contracting cooperation on the PurchaseProduct service. Once the buyer agent has found the prices from the different suppliers, it can choose its preferred supplier. This can happen either automatically by invoking a pre-programmed decision making process, or the buyer agent can graphically present the choices to the human buyer (e.g. via a web-based interface).

Having described the invention in particular exemplary details, those skilled in the art will recognize that the above description is merely illustrative of particular aspects and embodiments of the invention and is not intended to be limiting. The invention has a wider applicability and can be implemented using a wide array of techniques.

1. A runtime configurable component-based system comprising:
a plurality of services, each service having a set of properties describing the service, the properties including at least,
a set of configuration properties to describe functionalities of the service,
a lifecycle property to describe a state transition flow of the service for a specific runtime instance,
a state property to describe each state in the lifecycle, and
a set of dependency properties to describe inter-dependencies of the service with other services of the plurality of services while within a specific state in the lifecycle.

2. The system of claim 1 wherein the services have one or more dependent services.

3. The system of claim 1 wherein the specific runtime instance of the service is a peer service, the peer service being available externally to a plurality of agents to perform domain-specific tasks for a plurality of distributed business processes.

4. The system of claim 3 wherein the specific runtime instance of the service is a message service, the message service to provide communication between the peer services of the plurality of agents to perform the distributed business process and to describe a specific message transport protocol.

5. A method to initiate a runtime configurable component-based system comprising:
accessing deployment information having a list of one or more services to be created; and
instantiating each service into a corresponding service instance, each service instance being configured based on the deployment information, each service having the capability to communicate with each other to perform a distributed business process.

6. The method of claim 5 wherein each service has an initiated state, wherein the initiated state is active or inactive.

7. The method of claim 6 further comprising:
transitioning one of the services between the initiated states.

8. The method of claim 7 wherein upon transitioning, the one of the agent services sends a corresponding event to a dependent agent service.

9. The method of claim 5 wherein the deployment information is to be received from a deployment file.

10. The method of claim 5 wherein the deployment information includes configuration information and inter-dependency information.

11. The method of claim 5 further comprising:
halting one of the services, the service being in an inactive state prior to being halted.

12. The method of claim 5 wherein one of the services to be instantiated is a peer service.

13. The method of claim 5 wherein one of the services to be instantiated is a message service.

14. The method of claim 5 wherein one of the services to be instantiated is a communicator service.

15. The method of claim 5 wherein one of the services to be instantiated is a manager service.

16. The method of claim 5 wherein one of the services to be instantiated is a task scheduler service.

17. The method of claim 5 wherein one of the services to be instantiated is a directory service.

18. A runtime configurable component-based system framework comprising:
a plurality of peer services, each peer service being available externally to a plurality of agents to perform domain-specific tasks for a distributed business process; and
a plurality of message services, each message service to provide communication between the peer services of the plurality of agents to perform the distributed business process and to describe a specific message transport protocol.

19. The system of claim 18 wherein one of the plurality of message services is a HTTPMessageService to implement HTTP-based (Hyper Text Transport Protocol) messaging.

20. The system of claim 18 further comprising:
a communicator service to manage the plurality of message services for a specific node and to determine the message service to access based on a request received.

21. The system of claim 20 further comprising:
a manager service to manage each peer service for a specific node, upon receiving the request for a specific peer service within the specific node via the communicator service, the manager service to forward the request to the specific peer service.

22. The system of claim 18 further comprising:
a task scheduler service to handle services for the system on an execution level.

23. The system of claim 18 further comprising:
a directory service to locate peer services external to the system.

24. A runtime configurable component-based system framework comprising:
a plurality of peer services, each peer service being available externally to a plurality of agents to perform domain-specific tasks for a distributed business process;
a plurality of message services, each message service to provide communication between the peer services of the plurality of agents to perform the distributed business process and to describe a specific message transport protocol;
a communicator service to manage the plurality of message services for a specific node and to determine the message service to access based on a request received;
a manager service to manage each peer service for the specific node, upon receiving the request for a specific peer service within the specific node via the communicator service, the manager service to forward the request to the specific peer service;
a task scheduler service to handle services for the specific node on an execution level; and
a plurality of directory services, each directory service to locate peer services external to the specific node.
